(19) United States
(12) Patent Application Publication
(10) Pub. No.: US 2022/0162723 A1
(43) Pub. Date: May 26, 2022

(54) SURFACE-MODIFYING METHOD FOR STEEL MATERIAL AND STEEL STRUCTURE

(71) Applicant: OSAKA UNIVERSITY, Suita-shi, Osaka (JP)

(72) Inventors: Hidetoshi Fujii, Suita-shi (JP); Yoshiaki Morisada, Suita-shi (JP); Yasuhiro Aoki, Suita-shi (JP)

(73) Assignee: OSAKA UNIVERSITY, Suita-shi, Osaka (JP)

(21) Appl. No.: 17/441,569

(22) PCT Filed: Mar. 2, 2020
(86) PCT No.: PCT/JP2020/008623

§ 371 Date: Sep. 21, 2021

(30) Foreign Application Priority Data
Mar. 27, 2019 (JP) 2019-060873

(51) Int. Cl. C21D 10/00; B23K 20/12; C22C 38/16; C22C 38/06; C22C 38/04; C22C 38/02; C22C 38/00

(52) U.S. Cl. CPC C21D 10/00; B23K 20/1275; C22C 38/16; C22C 38/06; B23K 2103/04; C22C 38/02; C22C 38/002; C22C 38/001; C22C 38/04

(57) ABSTRACT

Provided are an effective and simple surface-modifying method for prolonging the life of a steel structure made of a steel material having a high sulfur (S) content, and a steel structure having a life prolonged by the surface-modifying method. A surface-modifying method for forming a friction stir region on the surface of a steel material by friction stir processing, wherein a sulfur (S) content of the steel material is 200 ppm or more.

### TECHNICAL FIELD

The present invention relates to a surface-modifying method of a steel material having a high sulfur content and a steel structure which is subjected to the surface modification.

### PRIOR ARTS

Sulfur contained in steel materials is basically a harmful component, and if the sulfur content is high, high-temperature cracking will occur during melt solidification due to welding or the like. On the other hand, in recent years, the sulfur content has been reduced as much as possible due to the sophistication of steelmaking technology, but there are some defective products whose content is not sufficiently reduced. With respect to such steel materials, it is extremely difficult to manufacture joints using melt welding and repair work accompanied by melt solidification.

Further, since most of the domestic infrastructure (general infrastructure such as bridges and highways and industrial infrastructure such as plants) was developed during the period of high economic growth, it is expected that the influence of its aging may accelerate in the future.

Specifically, in the contents reported on the website (http://www.pref.okayama.jp/page/dateil-66940.html) as “Extending the life of road bridges” by the Road Construction Division of Okayama Prefecture, it is said that “The road bridges managed by Okayama Prefecture are totally 3,085 bridges (as of March 2015) including 995 bridges with a bridge length of 15 m or more and 2,090 bridges with a bridge length of less than 15 m. Many of these bridges were constructed during the period of high economic growth, and the number of bridges after 50 years will increase from 514 bridges (20%) at present to 1852 bridges (74%) 20 years later, and it is expected that the number of bridges is aging rapidly.”

Under such circumstances, in order to appropriately deal with the problem of the aging infrastructure, it is necessary to urgently establish repair technology that can prolong the life of the aging infrastructure at low cost. Here, the melt welding is effective for repairing the steel structures, but the steel materials used during the period of high economic growth often contain a large amount of sulfur (S).

In the steel materials containing a large amount of sulfur (S), it has been known that, since low melting point compound remains at the grain boundaries of the parent material in the final solidification region of the welded portion during welding, and the grain boundary opens due to strain during solidification shrinkage, it is easy to cause high-temperature cracking. That is, it is extremely difficult to use the melt welding to prolong the life of the aging infrastructure.

On the other hand, in Patent Literature 1 (JP 2008-246501 A), there is proposed a method for improving development of the stress corrosion crack of the welded structure, characterized in that, in a welded structure formed by joining members with a welded material made of a nickel-based alloy or an austenite-based stainless steel, the friction stir processing is performed by moving a rotating tool on the surface of the welded portion or the surface of the welded portion and the member in the vicinity of the welded portion in a state of being pressed by a load in the direction perpendicular to the surface, and the columnar crystal direction of the portion treated by the friction stir processing where is subjected to the friction stir processing is the in-plane direction of the surface.

In the method for improving development of the stress corrosion crack of the welded structure described in Patent Literature 1, when setting the columnar crystal direction of the portion treated by the friction stir processing to the in-plane direction of the surface, the occurrence of the stress corrosion cracking in the welded portion is suppressed, and even if the stress corrosion cracking occurs in the welded portion, with respect to the cracking growth in the depth direction, since the columnar crystal direction is perpendicular to the stress corrosion cracking direction, it is possible to reduce the speed of the stress corrosion cracking growth to about 1/10 as compared with the case where the stress corrosion cracking occurs along the columnar crystal direction. As a result, the service life of the welded portion can be extended, and the life of the welded structure can be prolonged.

### CITATION LIST

### Patent Literature

Patent Literature 1: JP 2008-246501 A

### SUMMARY OF INVENTION

### Technical Problem

However, the method for improving development of the stress corrosion crack of the welded structure described in Patent Literature 1 is characterized in that the columnar crystal direction of the welded portion is the in-plane direction of the surface, and the target material that exerts the effect is limited to the welded portion made of the welding material of the nickel-based alloy and the austenite-based stainless steel. In addition, the effect on fatigue strength when not in a corrosive environment is not described, and the effect on steel materials with a high sulfur (S) content is not disclosed at all.

In view of the above problems in the prior art, an object of the present invention is to provide an effective and simple surface-modifying method for prolonging the life of a steel structure made of a steel material having a high sulfur (S) content, and a steel structure having a life prolonged by the surface-modifying method.

### Solution to Problem

In order to achieve the above object, the present inventors have conducted extensive studies as to the relationship between the sulfur (S) content of the steel material and the action and effect obtained by the friction stir processing, it has been found that, in case of the steel material where the sulfur (S) content is above a certain value, repair (surface modification) by using the friction stir processing is more effective than melt welding, and then the present invention has been reached.

Namely, the present invention can provide a surface-modifying method for forming a friction stir region on the surface of a steel material by friction stir processing, wherein a sulfur (S) content of the steel material is 200 ppm or more.

In the surface-modifying method of a steel material of the present invention, it is preferable that the sulfur (S) content is 300 ppm or more. When the sulfur (S) content of the steel material is 200 ppm or more, cracks are often induced during the melt welding, and when the content is 300 ppm or more, cracks occur in most cases. On the other hand, by the friction stir processing, which is a solid phase process where the steel material is not melted, a good modified region (friction stir region) can be obtained even for a steel material containing 200 ppm or more of sulfur (S), and even when the content is 300 ppm or more, a similarly good modified region (friction stir region) can be obtained.

FIG. 1 is a graph showing the relationship between the year of manufacture of bridge steel material and the sulfur (S) content (Yoshikazu Sugano, “Development and Future Prospects of Steel Structures and Supporting Steel”, 225.226th Nishiyama Memorial Technical Lecture, (2016), 49.), and there are many bridge steel materials in the 1960s to 1980s related to the above-mentioned aging problem which contain 0.02% (200 ppm) or more of sulfur (S). That is, the surface-modifying method of a steel material of the present invention can be suitably used for a steel material of an aged infrastructure.

The friction stir processing is not particularly limited as long as the effect of the present invention is not impaired, and the friction stir processing can be performed by various conventionally known methods. The friction stir processing utilizes the friction stir welding (FSW) which is a solid phase welding technology for metal materials, as a surface-modifying technology for metal materials.

Further, in the surface-modifying method of a steel material of the present invention, it is preferable that a region where cracks and/or corrosion holes are present is subjected to the friction stir processing. In the friction stir processing, the material flow of the steel material occurs in the modified region, and the material flow can remove the cracks and corrosion holes. Here, since cracks having a width of about 1 mm are removed by the material flow in the friction stir processing, the cracks and corrosion holes generally existing in the repair target region of the steel structure can be easily removed.

Further, in the surface-modifying method of a steel material of the present invention, it is preferable that a melt-welded portion of the steel material is subjected to the friction stir processing. Various steel materials are used for large welded structures such as ships, marine structures and bridges, and the fatigue strength of the parent material is improved by increasing the tension of the steel materials, but the reliability of the welded structure as a whole is rate-determined by the characteristics of the melt-welded portion, which has the lowest toughness and fatigue strength. In particular, in a steel material containing a large amount of sulfur (S), the toughness of the melt-welded portion is significantly lower than that of the parent material even when cracking in the melt-welded portion can be suppressed. That is, when a melt-welded portion is present in an aged steel structure, the life of the entire steel structure can be prolonged extremely efficiently by subjecting to the friction stir processing on the melt-welded portion.

Further, in the surface-modifying method of a steel material of the present invention, it is preferable that the plate thickness of the steel material is 6 to 600 mm. In various infrastructure structures, thick steel plates are used, and a sufficient long life can be achieved by modifying only the vicinity of the surface of the thick steel plates by the friction stir processing. Here, in order to form a deep friction stir region, it is necessary to use a tool (friction stir tool) having a protrusion (probe portion) corresponding to the depth, but if the probe portion is long, during the friction stir processing, tool breakage is easy to occur. On the other hand, according to the modifying method of a steel material of the present invention, since the desired effect can be obtained by forming a friction stir region in the vicinity of the surface of a thick steel plate, the treatment can be easily performed.

The depth of the friction stir region formed on the surface of the steel material is not particularly limited and may be appropriately determined depending on the shape, size, material, and the like of the steel structure, but is, for example, preferably 0.2 to 6 mm, more preferably 0.5 to 3 mm, most preferably 1 to 2 mm. When setting the thickness of the friction stir region within these ranges, it is possible to achieve both the life of the tool and the modification effect of forming the friction stir region.

Further, in the surface-modifying method of a steel material of the present invention, it is preferable that the steel material is any one of a rolled steel material for general structure, a rolled steel material for welded structure, a weather-resistant hot rolled steel material for welded structure, a rolled steel material for building structure, a carbon steel pipe for general structure, a carbon steel pipe for building structure, and a square steel pipe for general structure. These steel materials are used as bridges and building steel frames, and the friction stir region can be formed relatively easily by the friction stir process.

Further, in the surface-modifying method of a steel material of the present invention, it is preferable that a processing temperature of the friction stir processing is set to A₃ point or less or A_{cm} point or less, which is determined by the chemical composition of the steel material. When setting the processing temperature of at least a part of the friction stir region to A₃ point or less or A_{cm} point or less of the steel material, the parent material crystal grains of a part of the friction stir region become fine equiaxed grains (being not fragile transformation such as martensite), and thus the toughness can be improved more effectively. Further, the fragility caused by sulfur (S) can be reduced.

Further, in the surface-modifying method of a steel material of the present invention, it is preferable that a processing temperature of the friction stir processing is set to A₁ transformation point or less, which is determined by the chemical composition of the steel material. When setting the processing temperature of at least a part of the friction stir region to A₁ point or less of the steel material, the parent material crystal grains of a part of the friction stir region become fine equiaxed grains (being not fragile transformation such as martensite), and thus the toughness can be improved more effectively. Further, the fragility caused by sulfur (S) can be reduced. The processing temperature of the friction stir processing can be controlled by the material, shape, rotation speed, moving speed, load, and the like of the rotating tool which is inserted into the region to be processed. Moreover, various external cooling means may be used, if necessary.

Further, the present invention can also provide

a steel structure containing at least a part of a steel material, wherein

the sulfur (S) content of the steel material is 200 ppm or more, and

a friction stir region exists in the steel material.

In the steel structure of the present invention, the friction stir region exists on the surface of the steel material, and the hardness, strength, toughness, and the like of the steel material are adjusted by the friction stir region, so that the life of the steel structure can be prolonged. Further, it is preferable that the friction stir region contains equiaxed recrystallized grains. The presence of equiaxed recrystallized grains in the friction stir region can improve the toughness of the steel material. Here, the friction stirring region is not limited to those intended for surface modification, and may be a friction stirring region formed by friction stir welding.

Further, in the steel structure of the present invention, the sulfur (S) content is preferably 300 ppm or more. There are many bridge steel materials in the 1960s to 1980s related to the above-mentioned aging problem which contain 200 ppm or more of sulfur (S), and some of them contain 300 ppm of sulfur (S). In the steel structure of the present invention, even if the sulfur (S) content is 300 ppm or more, the life is prolonged due to the presence of the friction stir region.

Further, in the steel structure of the present invention, it is preferable that the plate thickness of the steel material is 6 to 600 mm. In various infrastructure structures, thick steel plates are used, and a sufficient long life can be achieved by modifying only the vicinity of the surface of the thick steel plates by the friction stir processing.

The depth of the friction stir region formed on the surface of the steel material is not particularly limited and may be appropriately determined depending on the shape, size, material, and the like of the steel structure, but is, for example, preferably 0.2 to 6 mm, more preferably 0.5 to 3 mm, most preferably 1 to 2 mm. When setting the thickness of the friction stir region within these ranges, it is possible to manufacture inexpensive and long-life steel structures.

Further, in the steel structure of the present invention, it is preferable that the steel material is any one of a rolled steel material for general structure, a rolled steel material for welded structure, a weather-resistant hot rolled steel material for welded structure, a rolled steel material for building structure, a carbon steel pipe for general structure, a carbon steel pipe for building structure, and a square steel pipe for general structure. When using these steel materials, the steel structures can be made into various infrastructure structures.

As long as the effect of the present invention is not impaired, the location of the friction stir region is not particularly limited, and it may be formed in a region where strength and reliability are desired to be improved as a steel structure. For example, when there are cracks or corrosion holes or when there is a melt-welded portion, the life of the steel structure as a whole can be prolonged by forming the friction stir region in the region.

### Effect of the Invention

According to the present invention, it is possible to provide an effective and simple surface-modifying method for prolonging the life of a steel structure made of a steel material having a high sulfur (S) content, and a steel structure having a life prolonged by the surface-modifying method.

### BRIEF DESCRIPTION OF THE DRAWINGS

FIG. 1 is a graph which shows the relationship between the manufacturing year of a bridge steel material, and the sulfur (S) content.

FIG. 2 is a schematic diagram of the surface-modifying method of a steel material of the present invention.

FIG. 3 is a schematic front view showing one example of the friction stir tool used in the surface-modifying method of a steel material of the present invention.

FIG. 4 is a schematic cross-sectional view of the vicinity of the friction stir region in the case where the friction stir region is formed in the melt-welded portion with respect to the steel structure of the present invention.

FIG. 5 is photographs of the appearance of the friction stir regions formed in Examples 1 to 3.

FIG. 6 is cross-sectional macro photographs of the friction stir regions formed in Examples 1 to 3.

FIG. 7 is microstructure photographs of the steel plates 1 to be tested to the steel plate 3 to be tested.

FIG. 8 is microstructure photographs of the friction stir regions formed on the steel plate 1 to be tested to the steel plate 3 to be tested under the high temperature treatment condition.

FIG. 9 is microstructure photographs of the friction stir regions formed on the steel plate 1 to be tested to the steel plate 3 to be tested under the low temperature treatment condition.

FIG. 10 is a graph showing the hardness distribution of the friction stir region and the vicinity thereof (steel plate 1 to be tested).

FIG. 11 is a graph showing the hardness distribution of the friction stir region and the vicinity thereof (steel plate 2 to be tested).

FIG. 12 is a graph showing the hardness distribution of the friction stir region and the vicinity thereof (steel plate 3 to be tested).

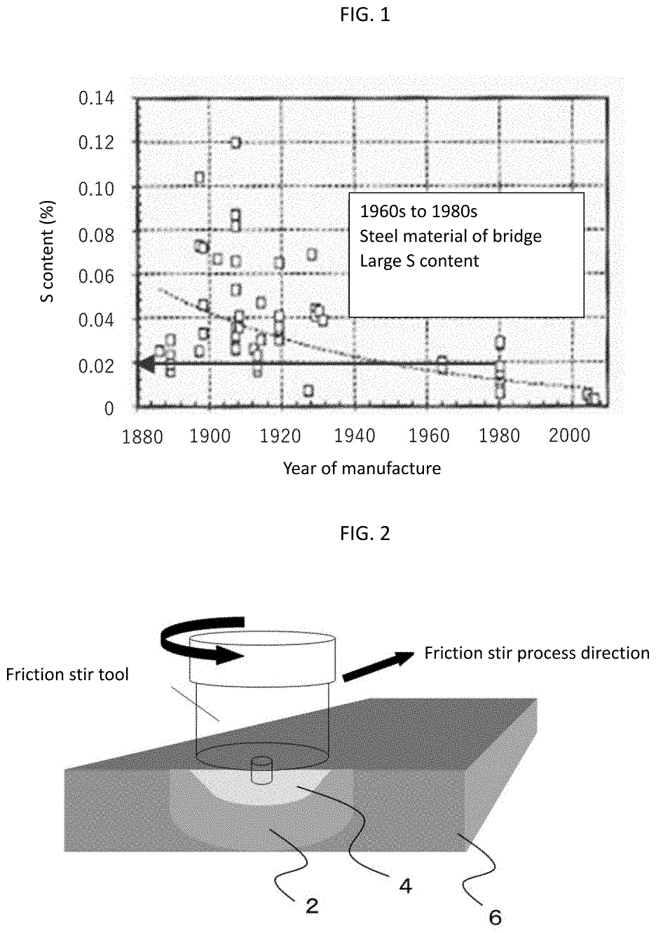

### EMBODIMENTS FOR ACHIEVING THE INVENTION

In the following, typical embodiments of the present invention are explained by referring the drawings, but the present invention is not limited only to these embodiments. In the following description, the same or corresponding part is designated by the same symbol, and there is a case that the redundant explanation is omitted. Further, since the drawing is to explain the concept of the present invention, there is a case that the sizes of the illustrated elements and a ratio thereof are different from the real case.

### (1) Surface-Modifying Method of Steel Material

FIG. 2 is a schematic diagram of the surface-modifying method of a steel material of the present invention. Note that FIG. 2 shows a case where the friction stir processing is applied to the melt-welded portion, and the friction stir region 4 is formed on the surface of the melt-welded portion 2 by the friction stir processing. Here, the greatest feature of the surface-modifying method for a steel material of the present invention is that the sulfur (S) content of the steel material 6 is 200 ppm or more, and the content is preferably 300 ppm or more.

Sulfur (S) is basically a harmful component for the steel material 6, and the sulfur (S) content in the steel material 6 is reduced as much as possible. That is, the sulfur (S) content of the steel material 6 currently produced is less than 200 ppm unless being intentionally mixed. On the other hand, in the steel material 6 manufactured before the 1980s, when the steelmaking technology did not reach the current level, there are many cases that the sulfur (S) content is often 200 ppm or more or 300 ppm or more.

Here, the method for measuring the sulfur (S) content of the steel material 6 is not particularly limited as long as the effect of the present invention is not impaired, and various conventionally known measuring methods can be used. As the measuring method, for example, the spark discharge emission spectroscopic analysis (cantback) or the wavelength dispersion type fluorescent X-ray analysis is preferably used, but a handy type energy dispersion type fluorescent X-ray analysis may be simply used.

Further, it is preferable that the plate thickness of the steel material 6 is 6 to 600 mm. In various infrastructure structures, thick steel plates are used, and a sufficient long life can be achieved by modifying only the vicinity of the surface of the thick steel plates by the friction stir processing.

The depth of the friction stir region 4 formed on the surface of the steel material 6 is not particularly limited and may be appropriately determined depending on the shape, size, material, and the like of the steel structure, but is, for example, preferably 0.2 to 6 mm, more preferably 0.5 to 3 mm, most preferably 1 to 2 mm. When setting the thickness of the friction stir region 4 within these ranges, it is possible to achieve both the life of the tool and the modification effect of forming the friction stir region 4.

Further, it is preferable that the steel material 6 is any one of a rolled steel material for general structure, a rolled steel material for welded structure, a weather-resistant hot rolled steel material for welded structure, a rolled steel material for building structure, a carbon steel pipe for general structure, a carbon steel pipe for building structure, and a square steel pipe for general structure. These steel materials are used as bridges and building steel frames, and the friction stir region 4 can be formed relatively easily by the friction stir processing.

Friction stir processing is an application of the friction stir welding to the surface modification of metal materials, and is basically the same technology as the friction stir welding except that the shape or the like of the tool used may differ. Specifically, it is a method of obtaining the friction stir region 4 by inserting a protrusion (probe portion) provided at the tip of a rotary tool into a material to be treated (steel material 6) and moving the rotary tool while rotating.

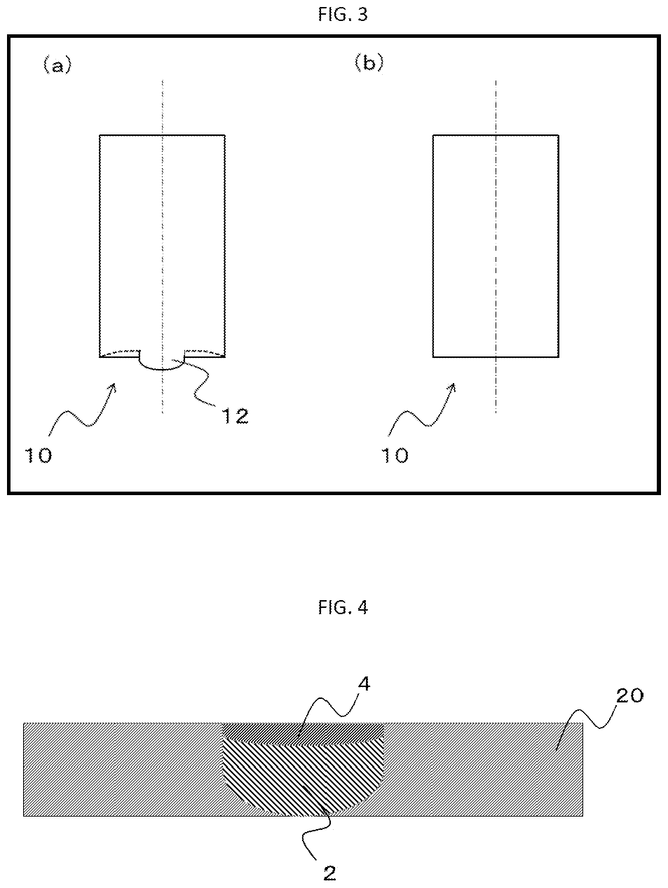

FIG. 3 is a schematic front view showing one example of the friction stir tool used in the surface-modifying method of a steel material of the present invention. The bottom surface of the friction stir tool 10 preferably has a probe 12 having a length of 3 mm or less, and more preferably a probe 12 having a length of 2 mm or less (FIG. 3a). It is also possible to use a flat tool (FIG. 3b) having a substantially flat bottom surface without the probe 12. Furthermore, a tool that does not have the probe 12 and has a convex bottom surface of the friction stir tool 10 can also be used. Particularly, by using a tool having a spherical crown on the bottom surface of the friction stir tool 10, the tool life can be improved and the processing cost of the friction stir processing can be reduced. Further, by forming the bottom surface of the friction stir tool 10 into the spherical crown shape, the friction stir region 4 can be formed deeper than in the case of a flat surface.

When the friction stir tool 10 having the probe 12 is press-inserted into the steel material 6 having a high melting point and high temperature deformation resistance and moved, it often breaks from the root of the probe 12 and the life of the friction stir tool 10 expires. On the other hand, by using the friction stir tool 10 having a substantially flat bottom surface or a spherical crown shape, it is not necessary to consider the tool life due to the breakage of the probe 12, and by using the friction stir tool 10 having the probe 12 with a length of 2 mm or less, it is possible to suppress breakage of the probe 12.

The shape of the probe 12 is not particularly limited, and a simple columnar shape, a tapered shape having a thick root and a thin tip, or the like can be used. The probe 12 may be processed by threading, chamfering, or the like, but from the viewpoint of tool life, it is preferable not to perform such processing.

When forming the bottom surface of the friction stir tool 10 into a substantially flat surface or a spherical crown shape, the range of materials that can be used as the material of the friction stir tool 10 can be widened. In the case that the probe 12 is not provided, since the shape of the friction stir tool 10 is basically columnar, it is possible to use a difficult-to-sinter material or a difficult-to-process material. The friction stir tool 10 that can be used in the present invention includes a tool having a concave bottom surface.

The material of the friction stirring tool 10 is, for example, a tool steel such as SKD61 steel specified in JIS, a cemented carbide made of tungsten carbide (WC), cobalt (Co), nickel (Ni), and a cobalt (Co)-based alloy, a tungsten (W) alloy, a high melting point metal such as iridium (Ir) and its alloy, or a ceramic such as Si₃N₄ or PCBN. Here, when the material 6 to be welded is a steel material such as high-strength steel, it is preferable to use the cemented carbide made of tungsten carbide (WC), cobalt (Co), and the cobalt (Co)-based alloy, the high melting point metal such as iridium (Ir) and its alloy, or the ceramic such as Si₃N₄ or PCBN.

The structure of the friction stir region 4 obtained by the friction stir processing is finer and more homogenized in comparison with the melt-welded portion 2 having the quenching solidification structure and the parent material of the steel material 6. Further, though the toughness of the melt-welded portion 2 is significantly lower than that of the parent material, as a result of intensive research by the inventors, it has been found that, when forming the friction stir region 4 having excellent mechanical properties on the surface of the melt-welded portion 2, the reliability of the entire steel structure can be ensured.

Further, it is preferable that a processing temperature of the friction stir processing is set to A₃ point or less or A_{cm} point or less, which is determined by the chemical composition of the steel material 6. When setting the processing temperature of at least a part of the friction stir region 4 to A₃ point or less or A_{cm} point or less of the steel material 6, the parent material crystal grains of a part of the friction stir region 4 become fine equiaxed grains (being not fragile transformation such as martensite), and thus the toughness can be improved more effectively. Further, the fragility caused by sulfur (S) can be reduced.

Here, the toughness of the friction stir region 4 can be evaluated by measuring the impact absorption energy by, for example, a micro-impact test by using a micro test piece cut out from the region. More specifically, the impact absorption energy can be calculated by forming a notch at a place where the impact absorption energy is measured, and integrating the load displacement curve when the impact is applied to the place.

When the impact absorption energy of the friction stir region 4 is 80% or more of the impact absorption energy of the steel material 6, high reliability can be imparted to the steel structure, and, for example, it can be suitably used as a structure that requires high reliability for a long period of time such as a bridge or an offshore structure. The impact absorption energy of the friction stir region 4 is preferably 90% or more, more preferably 95% or more, most preferably 100% or more of the impact absorption energy of the steel material 6.

Further, it is preferable that a processing temperature of the friction stir processing is set to A₁ transformation point or less, which is determined by the chemical composition of the steel material 6. When setting the processing temperature of at least a part of the friction stir region 4 to A₁ point or less of the steel material 6, the parent material crystal grains of a part of the friction stir region 4 become fine equiaxed grains (being not fragile transformation such as martensite), and thus the toughness can be improved more effectively. Further, the fragility caused by sulfur (S) can be reduced. The processing temperature of the friction stir processing can be controlled by the material, shape, rotation speed, moving speed, load, and the like of the tool 10 for the friction stir processing which is inserted into the region to be processed. Moreover, various external cooling means may be used, if necessary.

The friction stir processing in the present invention includes (1) a mode in which the friction stir tool 10 is rotated and moved in the processing direction, and (2) a mode in which the friction stir tool 10 is rotated and stayed at the processing position, (3) a mode of superimposing the processing regions formed in (1), (4) a mode of superimposing the processing regions formed in (2), and (5) a mode in which the processes of (1) to (4) are arbitrarily combined.

### (2) Steel Structure

The steel structure of the present invention provides a steel structure having the friction stir region 4 formed by the aforementioned surface-modifying method of a steel material of the present invention. When the region that rate-determines the mechanical properties of the entire steel structure (particularly the region where the reliability is seriously deteriorated due to aging) is modified in the friction stir region 4, it is possible to obtain the steel structure where the mechanical properties of the steel material 6 are sufficiently expressed.

FIG. 4 shows a schematic cross-sectional view of the vicinity of the friction stir region in the case where the friction stir region is formed in the melt-welded portion with respect to the steel structure of the present invention. In the steel structure of the present invention, the sulfur (S) content of the steel material 6 is 200 ppm or more, and the content is preferably 300 ppm or more. Further, it is preferable that the friction stir region 4 contains the equiaxed recrystallized grains. The presence of the equiaxed recrystallized grains (recrystallized ferrite grains) in the friction stir region 4 can improve the toughness of the steel material 6.

It is preferable that the plate thickness of the steel material 6 is 6 to 600 mm. In various infrastructure structures, thick steel plates are used, and a sufficient long life can be achieved by modifying only the vicinity of the surface of the thick steel plates by the friction stir processing.

The depth of the friction stir region 4 formed on the surface of the steel material 6 is not particularly limited and may be appropriately determined depending on the shape, size, material, and the like of the steel structure, but is, for example, preferably 0.2 to 6 mm, more preferably 0.5 to 3 mm, most preferably 1 to 2 mm. When setting the thickness of the friction stir region 4 within these ranges, it is possible to manufacture inexpensive and long-life steel structures.

Further, it is preferable that the steel material 6 is any one of a rolled steel material for general structure, a rolled steel material for welded structure, a weather-resistant hot rolled steel material for welded structure, a rolled steel material for building structure, a carbon steel pipe for general structure, a carbon steel pipe for building structure, and a square steel pipe for general structure. When using these steel materials, the steel structures can be made into various infrastructure structures.

As long as the effect of the present invention is not impaired, the location of the friction stir region 4 is not particularly limited, and it may be formed in a region where strength and reliability are desired to be improved as a steel structure. For example, when there are cracks or corrosion holes or when there is a melt-welded portion, the life of the steel structure as a whole can be prolonged by forming the friction stir region 4 in the region.

In the steel structure of the present invention, it is not necessary that the region where cracks and corrosion holes exist and all the regions of the melt-welded portion are modified, but it is preferable that the friction stir region 4 is formed in the region where the mechanical properties of the steel structure is rate-determined.

In the above, the typical embodiments of the present invention are explained, but the present invention is not limited to these embodiments, and various changes in design may be possible, those changes may be included within the scope of the present invention.

### EXAMPLE

### Example 1

### 0.03% by Mass S Steel Plate

A steel ingot having the target composition shown in TABLE 1 was prepared by vacuum induction melting, and hot rolling at 950° C. was performed to obtain a steel plate having 90 mm (thickness)×145 mm (width)×380 mm (length). Then, after sawing to make a plate having 90 mm (thickness)×145 mm (width)×180 mm (length), the plate thickness thereof was made to 4.5 mm by hot rolling at 950° C. The values shown in TABLE 1 are % by mass.

TABLE 1

| | C | Si | Mn | Cu | P | S | Al | N | O | Fe |
|---|---|---|---|---|---|---|---|---|---|---|
| Ex. 1 | 0.10 | 0.010 | 0.40 | Result | 0.010 | 0.030 | 0.010 | 0.0040 | Result | Bal. |
| EX. 2 | 0.10 | 0.010 | 0.40 | Result | 0.010 | 0.060 | 0.010 | 0.0040 | Result | Bal. |
| Ex. 3 | 0.10 | 0.010 | 0.40 | Result | 0.010 | 0.100 | 0.010 | 0.0040 | Result | Bal. |

Then, the steel plate was inserted into a furnace heated to 950° C., held for 15 minutes, taken out, and air-cooled. Finally, a finishing cutting process was performed to obtain a steel plate 1 to be tested having a size of 4.5 mm (thickness)×100 mm (width)×200 mm (length). TABLE 2 shows the composition of the steel plate 1 to be tested in % by mass which was measured by the spark discharge emission spectroscopic analysis (cantback). The content of sulfur (S) is 0.027% by mass.

TABLE 2

| | C | Si | Mn | Cu | P | S | Al | N | O | Fe |
|---|---|---|---|---|---|---|---|---|---|---|
| Ex. 1 | 0.10 | 0.003 | 0.38 | <0.01 | 0.011 | 0.027 | 0.008 | 0.0048 | 0.0014 | Bal. |
| EX. 2 | 0.10 | 0.003 | 0.38 | <0.01 | 0.010 | 0.053 | 0.013 | 0.0049 | 0.0010 | Bal. |
| Ex. 3 | 0.10 | 0.003 | 0.38 | <0.01 | 0.010 | 0.100 | 0.009 | 0.0053 | 0.0010 | Bal. |

By using a cemented carbide tool (the probe does not have a screw) having a shape of a shoulder diameter of 15 mm, a probe diameter of 6 mm, and a probe length of 2.9 mm, the steel plate 1 to be tested was subjected to the friction stir processing (the high temperature treatment condition: A₃ point or more) under the conditions of the tool rotation speed: 400 rpm, welding speed: 150 mm/min, welding load: 2.5 ton, tool advance angle: 3°, and welding atmosphere: Ar to form the friction stir region on the surface of the steel plate 1 to be tested.

Further, by using a cemented carbide tool (the probe does not have a screw) having a shape of a shoulder diameter of 15 mm, a probe diameter of 6 mm, and a probe length of 2.9 mm, the steel plate 1 to be tested was also subjected to the friction stir processing (the low temperature treatment condition: A₁ transformation point or less) under the conditions of the tool rotation speed: 100 rpm, welding speed: 150 mm/min, welding load: 4.5 ton, tool advance angle: 3°, and welding atmosphere: Ar to form the friction stir region on the surface of the steel plate 1 to be tested.

### Example 2

### 0.06% by Mass S Steel Plate

A steel plate 2 to be tested was obtained in the same manner as in Example 1 except that a steel ingot having a target composition of the value of Example 2 shown in TABLE 1 was produced. The actual composition of the steel plate 2 to be tested is as shown in TABLE 2, and the sulfur (S) content is 0.053% by mass. Further, in the same manner as in Example 1, the friction stir process was performed under the high temperature treatment condition and the low temperature treatment condition.

### Example 3

### 0.10% by Mass S Steel Plate

A steel plate 3 to be tested was obtained in the same manner as in Example 1 except that a steel ingot having a target composition of the value of Example 3 shown in TABLE 1 was produced. The actual composition of the steel plate 3 to be tested is as shown in TABLE 2, and the sulfur (S) content is 0.100% by mass. Further, in the same manner as in Example 1, a friction stir process was performed under high temperature treatment condition and low temperature treatment condition.

### [Evaluation Test]

### (1) Cross-Section Macro Observation and Structure Observation

After cutting out the region including the friction stir region perpendicular to the friction stir processing direction, and polishing and electrolytically corroding (perchlorite+acetic acid) the cross section, the cross-section macro observation and the microstructure observation were performed with an optical microscope. Emery paper (#600 to # 4000) was used for polishing. A sample for observing the parent material was also prepared in the same manner.

### (2) Vickers Hardness Measurement

A cross-sectional sample was prepared in the same manner as in (1), and the horizontal distribution of Vickers hardness in and in the vicinity of the friction stir region were measured. The measurement was performed by using a micro-hardness meter FM-300 (available from Future Tech Co., Ltd.) with a measurement load of 300 gf and a holding time of 15 s.

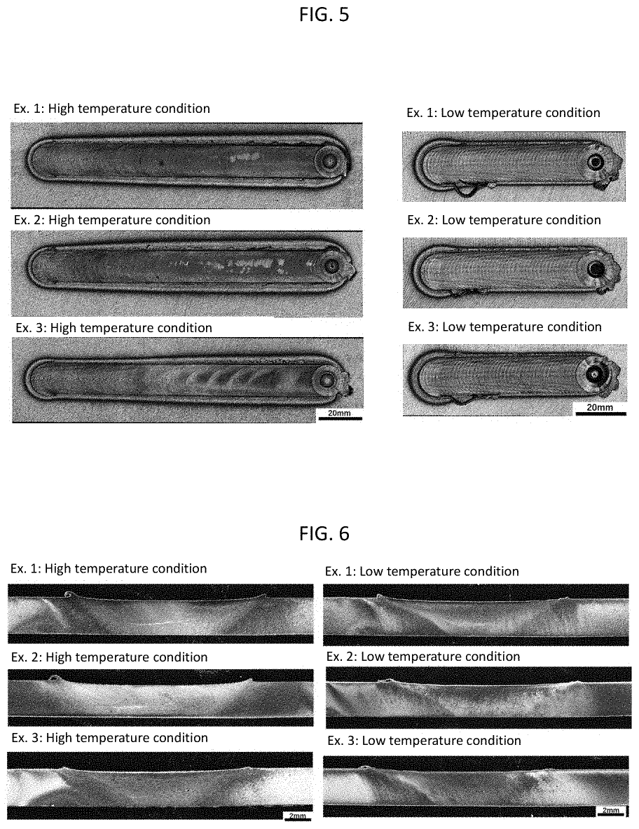

FIG. 5 shows photographs of the appearance (photographs of surface) of the friction stir regions formed in Examples 1 to 3. It can be seen that no crack or the like is generated in all the friction stir regions and their vicinity, and a good friction stir region is obtained. The results show that even when the sulfur (S) content of the steel material is high, the surface modification and the friction stir welding by the friction stir processing are possible.

Further, FIG. 6 shows cross-sectional macro photographs of the friction stir regions formed in Examples 1 to 3. Even in the cross section, It can be seen that no crack or the like was generated in all the friction stir regions and their vicinity, and even when the sulfur (S) content of the steel material was high, a good friction stir region was obtained.

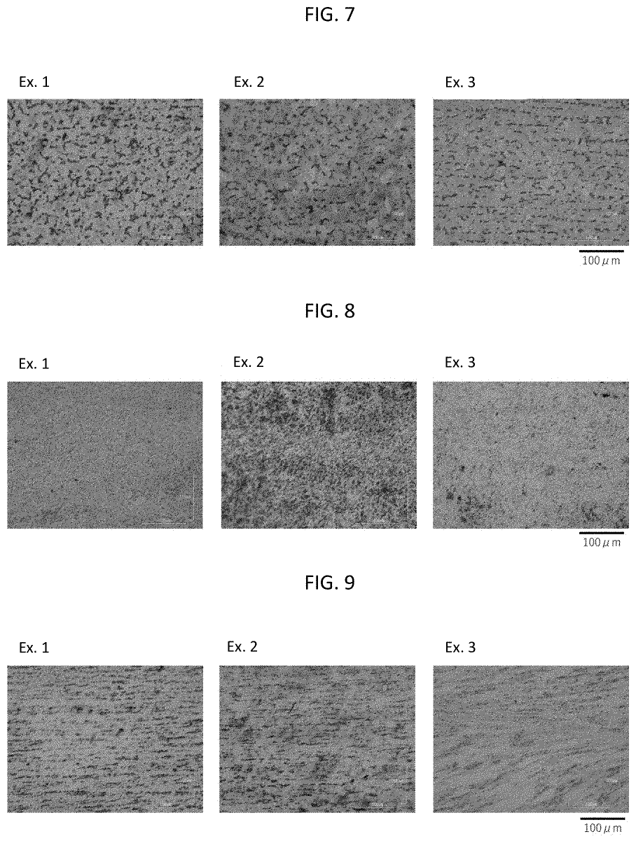

The structure photographs of the steel plate 1 to be tested to the steel plate 3 to be tested are shown in FIG. 7, the structure photographs of the friction stir regions formed on the steel plate 1 to be tested to the steel plate 3 to be tested under the high temperature treatment condition is shown in FIG. 8, the structure photographs of the friction stir regions formed on the steel plate 1 to be tested to the steel plate 3 to be tested under the low temperature treatment condition is shown in FIG. 9, respectively. All of them have a structure basically composed of ferrite-pearlite, but it can be seen that the structure of the friction stir region is finer than the structure of the steel materials to be tested. Further, in the friction stir region formed under the high temperature condition, the segregation of sulfur is suppressed (particularly, the steel plate 1 to be tested and the steel plate 3 to be tested in FIG. 8), and if desired to suppress the segregation of sulfur, it is preferable to carry out the friction stir processing at a temperature of A₃ or more. On the other hand, in the friction stir processing below the A₁ transformation point, the grain boundaries increase due to the refinement of the crystal grains of the parent material, and the sulfur segregated at the crystal grain boundaries can be diluted to some extent.

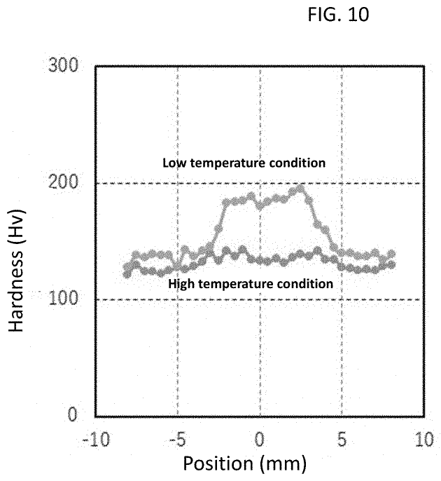

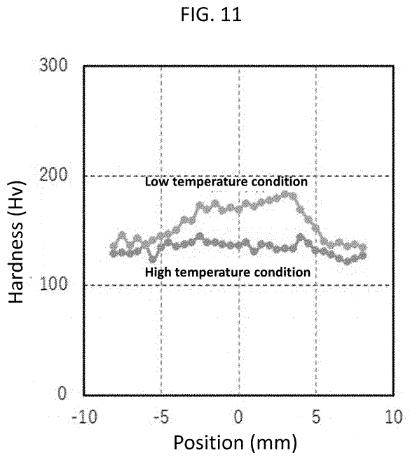

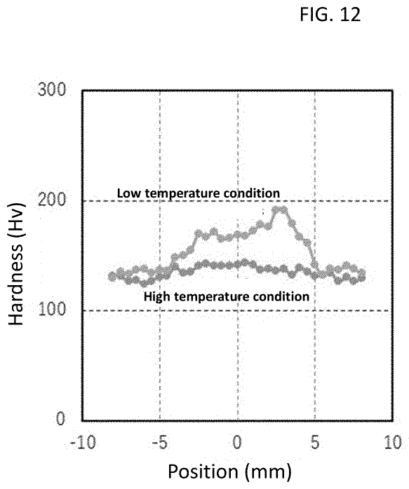

The results of the steel plates 1 to 3 to be tested are shown in FIG. 10 to FIG. 12, respectively, with respect to the hardness distribution of the friction stir region formed under the high temperature treatment condition and the low temperature treatment condition. The hardness of the friction stir region obtained under the high temperature condition is about the same as that of the parent material, and the hardness of the friction stir region obtained under the low temperature condition is higher than that of the parent material. The results show that the hardness of the friction stir region can be controlled by the friction stir processing condition, and the friction stir processing condition may be determined according to the desired characteristics (hardness, strength, toughness, etc.). Since the friction stir region formed under the low temperature treatment condition contains the equiaxed grains, it can be suitably applied to the surface modification (prolonging the life) of the steel material constituting the aged infrastructure. In addition, since the hardness of the friction stir region obtained under the low temperature condition increases as the sulfur content increases, when a higher surface hardness is required, it is preferable to apply the friction stir processing to the steel materials having a high sulfur content.

### EXPLANATION OF SYMBOLS

2 . . . Melt-welded portion,
4 . . . Friction stir region,
6 . . . Steel material,
10 . . . Friction stir tool,
12 . . . Probe.

1. A surface-modifying method for forming a friction stir region on the surface of a steel material by friction stir processing, wherein a sulfur (S) content of the steel material is 200 ppm or more.

2. The surface-modifying method of a steel material according to claim 1, wherein the content is 300 ppm or more.

3. The surface-modifying method of a steel material according to claim 1, wherein a region where cracks and/or corrosion holes are present is subjected to the friction stir processing.

4. The surface-modifying method of a steel material according to claim 1, wherein a melt-welded portion of the steel material is subjected to the friction stir processing.

5. The surface-modifying method of a steel material according to claim 1, wherein a plate thickness of the steel material is 6 to 600 mm.

6. The surface-modifying method of a steel material according to claim 1, wherein the steel material is any one of a rolled steel material for general structure, a rolled steel material for welded structure, a weather-resistant hot rolled steel material for welded structure, a rolled steel material for building structure, a carbon steel pipe for general structure, a carbon steel pipe for building structure, and a. square steel pipe for general structure.

7. The surface-modifying method of a steel material according to claim 1, wherein a processing temperature of the friction stir processing is set to A₃ point or less or A_{cm} point or less, which is determined by the chemical composition of the steel material.

8. The surface-modifying method of a steel material according to claim 1, wherein a processing temperature of the friction stir processing is set to A₁ transformation point or less, which is determined by the chemical composition of the steel material.

9. A steel structure containing at least a part of a steel material, wherein
the sulfur (S) content of the steel material is 200 ppm or more, and
a friction stir region exists in the steel material.

10. The steel structure according to claim 9, wherein the content is 300 ppm or more.

11. The steel structure according to claim 9, wherein the steel material has a plate thickness of 6 to 600 mm.

12. The steel structure according to claim 9, wherein the steel material is any one of a rolled steel material for general structure, a. rolled steel material for welded structure, a weather-resistant hot rolled steel material for welded structure, a. rolled steel material for building structure, a carbon steel pipe for general structure, a. carbon steel pipe for building, structure, and a square steel pipe for general structure.

13. The steel structure according to claim 9, wherein the friction stir region contains equiaxed recrystallized grains.
